(19) United States
(12) Patent Application Publication
(10) Pub. No.: US 2025/0284917 A1
(43) Pub. Date: Sep. 11, 2025

(54) SERIAL INKJET PRINTER, RECORDING MEDIUM STORING PROGRAM CODE, AND PRINTING SYSTEM

(71) Applicant: Takeshi IWASAKI, Kanagawa (JP)

(72) Inventor: Takeshi IWASAKI, Kanagawa (JP)

(73) Assignee: Ricoh Company, Ltd., Tokyo (JP)

(21) Appl. No.: 19/042,643

(22) Filed: Jan. 31, 2025

(30) Foreign Application Priority Data
Mar. 6, 2024 (JP) 2024-033774

(51) Int. Cl. G06K 15/02; B41J 2/045; B41J 2/15; B41J 3/46

(52) U.S. Cl. CPC G06K 15/1884; B41J 2/04551; B41J 2/04586; B41J 2/15; B41J 3/46; G06K 15/1876; G06K 2215/101

(57) ABSTRACT

A serial inkjet printer includes circuitry configured to select a printing mode according to a first result of comparison of a document size in image data with a first threshold and a second result of comparison of a reduction ratio of an image size of an output image from the document size with a second threshold, and downsize the image data at the reduction ratio in the printing mode to print the output image.

### CROSS-REFERENCE TO RELATED APPLICATION

This patent application is based on and claims priority pursuant to 35 U.S.C. § 119 (a) to Japanese Patent Application No. 2024-033774, filed on Mar. 6, 2024, in the Japan Patent Office, the entire disclosure of which is hereby incorporated by reference herein.

### BACKGROUND

### Technical Field

The present disclosure relates to a serial inkjet printer, a recording medium storing program code, and a printing system.

### Background Art

Inkjet printers discharge ink in the form of particles to form an image on print media such as a sheet. The inkjet printers that discharge ink while a printing head is moving in the main scanning direction are referred to as serial inkjet printers. Each serial inkjet printer has several printing modes so that a user can select a printing mode in consideration of the image quality required for a printed matter or the length of printing time. Some serial inkjet printers have a function to select an optimal printing mode in an automatic manner depending on, for example, the type of print media.

In such serial inkjet printers, the resolution of an image is automatically switched in consideration of image quality. Facsimile machines with several resolution modes and an image reduction unit calculate the degree of deterioration in the image quality of a downsized image in comparison to the original document, and automatically select a low-resolution mode with which high-speed communication can be carried out within a range where the image quality does not deteriorate.

### SUMMARY

The present disclosure described herein provides a serial inkjet printer, a non-transitory computer-readable recording medium storing a program for causing a computer to execute a method, and a printing system. The serial inkjet printer includes circuitry configured to select a printing mode according to a first result of comparison of a document size in image data with a first threshold and a second result of comparison of a reduction ratio of an image size of an output image from the document size with a second threshold, and downsize the image data at the reduction ratio in the printing mode to print the output image. The method includes reducing image data to an output image smaller than a document size of the image data, determining a printing mode according to a first result of comparison of the document size with a first threshold and a second result of comparison of a reduction ratio of an image size of the output image from the document size with a second threshold, and sending the printing mode determined in the determining to a serial inkjet printer. The printing system includes the serial inkjet printer to print image data with the image data reduced to an output image smaller than a document size of the image data, and a terminal device to communicate with the serial inkjet printer through a network. The terminal device includes first circuitry configured to determine a printing mode according to a first result of comparison of the document size with a first threshold and a second result of comparison of a reduction ratio of an image size of the output image from the document size with a second threshold, and send the printing mode to the serial inkjet printer. The serial inkjet printer includes second circuitry configured to downsize the image data at the reduction ratio to print the output image in the printing mode sent from the terminal device.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a schematic flowchart of controlling processes for printing modes.

FIG. 2 is a perspective view of a serial inkjet printer.

FIG. 3 is a side view of a serial inkjet printer.

FIG. 4 is a diagram illustrating a hardware configuration of a serial inkjet printer.

FIG. 5 is a schematic diagram illustrating a resolution in a high-speed printing mode and a resolution in a high-quality printing mode.

FIG. 6A and FIG. 6B are diagrams illustrating misregistration in the landing position of ink in bidirectional printing.

FIG. 7A and FIG. 7B are other diagrams illustrating misregistration in the landing position of ink in bidirectional printing.

FIG. 8A and FIG. 8B are diagrams each of which illustrates a printing-mode setting screen displayed by a serial inkjet printer.

FIG. 9 is a functional block diagram of a serial inkjet printer.

FIG. 10 is a functional block diagram of a main controller.

FIG. 11 is a flowchart of controlling processes in which a main controller automatically selects a printing mode when the size is to be reduced in printing.

FIG. 12 is a diagram depicting the details of three printing modes.

FIG. 13 is a diagram illustrating a printing-mode setting screen.

FIG. 14 is a table depicting conditions for switching a printing mode in a when-size-reduced image quality mode.

FIG. 15 is a flowchart of controlling processes in which a main controller automatically selects a printing mode when the size is to be reduced in printing.

FIG. 16 is a flowchart of controlling processes in which a main controller automatically selects a printing mode when the size is to be reduced in printing.

FIG. 17 is a diagram illustrating a system configuration of a printing system.

FIG. 18 is a block diagram illustrating a hardware configuration of a terminal device.

FIG. 19 is a diagram illustrating functional blocks of a terminal device and a serial inkjet printer in a printing system.

FIG. 20 is a data sequence diagram illustrating the processes of printing image data of a large document size in a reduced size by a printing system.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific integrated circuits (ASICs), field-programmable gate arrays (FPGAs), computers, or the like. These terms may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

A serial inkjet printer and a printing method implemented by a serial inkjet printer are described below with reference to the accompanying drawings.

The serial inkjet printer has a high-speed printing mode in which priority is given to printing speed. In such a high-speed printing mode, the pixel density is reduced, and the scan rate of a carriage is increased. However, in the high-speed printing mode, the image quality deteriorates due to a decrease in the precision of the ink landing position or bleeding or feathering of ink caused by large ink droplets to be discharged.

By contrast, in the high-quality printing mode where priority is given to image quality, the serial inkjet printer reduces the size of the liquid droplets, and increases the scanning density in the main scanning direction and the sub-scanning direction. In the case of the serial inkjet printer, the direction in which ink is discharged may be limited to one direction, i.e., the main scanning direction, to increase the precision off the ink landing position. By so doing, the image quality can be increased. However, the printing speed decreases.

The serial inkjet printer that can print an output image of large size such as an A0 or A1 takes a long time to print such an output image of large size. For this reason, in many cases, the default printing mode is initially set to the high-speed printing mode.

As long as the printing is conducted with unity magnification, even in the high-speed printing mode, the scan rate or the size of ink droplets can be adjusted so as not to cause significant deterioration in image quality. However, when the printing is not conducted with unity magnification and the image data of a large document size such as A0 or A1 is reduced to a small output image of, for example, A3 or A4, there are some cases in which the image quality deteriorates. In cases where the size is to be reduced in printing with a small reduction ratio (printed output image/document size of image data) such as cases where an image of A0 or A1 size is reduced to an image of A3 or A4 size, the size of texts decreases after the size reduction, and the lines get thinner. Accordingly, when the serial inkjet printer 100 reduces the size in printing by default in the high-speed printing mode, the image quality significantly deteriorates, the definition of texts is lost, and the reproducibility of lines deteriorates.

The high-quality printing mode is a printing mode in which an output image whose image quality is relatively higher than the image quality in a certain printing mode, i.e., the high-speed printing mode when two printing modes are available, is printed. The high-speed printing mode is a printing mode in which printing is conducted at a speed relatively faster than the speed in a certain printing mode, i.e., the high-quality printing mode when two printing modes are available.

The document size in the image data corresponds to the size of an output image when printing is conducted with no downsizing or magnification. The document size in the image data is set in a file that stores the image data. The document size may be the values specified in, for example, the Japanese Industrial Standards (JIS) such as A0, or may be defined by dimensions.

When printing is conducted with the document size of the image data reduced, the serial inkjet printer selects a high-quality printing mode according to the document size and the reduction ratio of the image data.

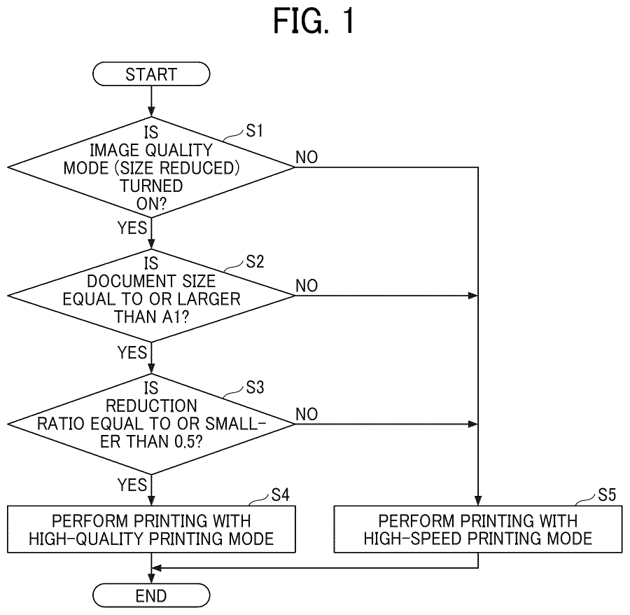

FIG. 1 is a schematic flowchart of controlling processes for printing modes.

Firstly, in step S1, the serial inkjet printer 100 determines whether an image quality mode (size reduced) is selected. In the when-size-reduced image quality mode, when the serial inkjet printer reduces the size in printing, the high-speed printing mode is automatically changed to the high-quality printing mode based on certain conditions. Accordingly, a reduction in image quality is prevented.

When it is determined to be YES in step S1, the process proceeds to step S2. When it is determined to be NO in step S1, the process proceeds to step S5.

In step S2, the serial inkjet printer 100 determines whether the document size is equal to or larger than A1. The document size refers to an image size in image data. When an A0 document is to be printed with no downsizing or magnification, the document size is A0. In the present embodiment, the document sizes that are defined in the JIS, for example, A0 to A4, are used. However, no limitation is intended thereby, and the document size may be defined by dimensions. A1 is an example of a first threshold used to determine whether the document size is large, and the document size may be compared with a threshold such as A0 or A2.

When the determination in step S2 is YES, the process proceeds to step S3. When the determination in step S2 is NO, the process proceeds to step S5.

In step S3, the serial inkjet printer 100 determines whether the reduction ratio is equal to or smaller than 0.5.

0.5 is an example of a second threshold to determine whether the reduction ratio is small, and the reduction ratio may be compared with a threshold other than 0.5.

When the determination in step S3 is YES, the process proceeds to step S4. When the determination in step S3 is NO, the process proceeds to step S5.

In step S4, the serial inkjet printer 100 sets the printing mode to the high-quality printing mode, and prints the image data as an output image. In the high-quality printing mode, the size of the ink droplets is reduced, and the scanning density in the main scanning direction and the sub-scanning direction is increased.

In step S5, the serial inkjet printer 100 selects the high-speed printing mode and prints the image data as an output image as the document size is not large or the reduction ratio is not small.

As described above, when the document size is large and the reduction ratio is small, the serial inkjet printer selects a high-quality printing mode and performs printing. Accordingly, the deterioration in image quality can be controlled when print image data of a large document size such as A0 or A1 is reduced to a small output image of, for example, A3 or A4 and printing is conducted.

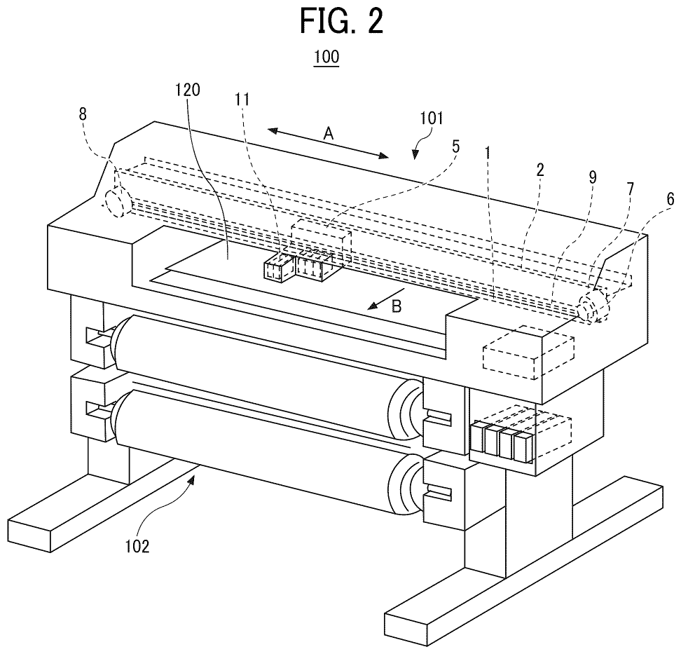

FIG. 2 is a perspective view of the serial inkjet printer 100.

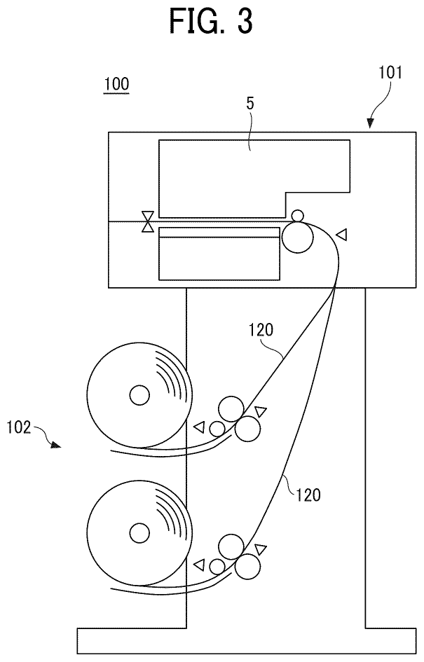

FIG. 3 is a side view of the serial inkjet printer 100.

The serial inkjet printer 100 is provided with a housing 101 and a roll-sheet feeder unit 102 arranged under the housing 101. The carriage 5 inside the housing 101 is held by a guide rod 1 and a guide stay 2 so as to be movable in the directions indicated by an arrow A, which is parallel to the main scanning direction and the direction in which the carriage 5 moves. The carriage 5 is moved back and forth in the main scanning direction by a main-scanning motor 6, a driving pulley 7 driven to rotate by the main-scanning motor 6, a driven pulley 8, and a timing belt 9 looped around the driving pulley 7 and the driven pulley 8.

The carriage 5 includes an ink-droplet discharge head 11. In the ink-droplet discharge head 11, a plurality of ink-droplet discharge heads that discharge ink droplets of different colors such as black (K), yellow (Y), magenta (M), and cyan (C) and a plurality of head tanks that supply those ink-droplet discharge heads with ink droplets are combined together. At the bottom of the ink-droplet discharge head 11, rows of nozzles are arrayed in the sub-scanning direction orthogonal to the main scanning direction. The ink-droplet discharge head 11 is mounted on the carriage 5 such that the ink droplets will be discharged toward a sheet placed underneath.

The roll sheet 120 is fed to the housing 101 from the roll-sheet feeder unit 102, and is intermittently conveyed in the direction indicated by an arrow B, which is parallel to the sub-scanning direction, the sheet conveyance direction, and a direction orthogonal to the main scanning direction of the carriage 5.

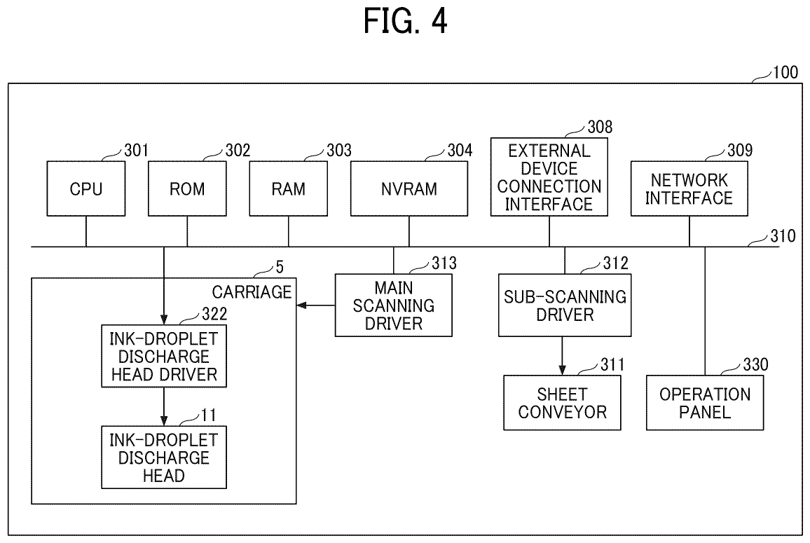

FIG. 4 is a diagram illustrating a hardware configuration of the serial inkjet printer 100.

As illustrated in FIG. 4, the serial inkjet printer 100 includes a central processing unit (CPU) 301, a read-only memory (ROM) 302, a random-access memory (RAM) 303, a non-volatile random access memory (NVRAM) 304, an external device connection interface 308, a network interface 309, and a bus line 310.

Moreover, the serial inkjet printer 100 is provided with a sheet conveyor 311, a sub-scanning driver 312, a main scanning driver 313, a carriage 5, and an operation panel 330. Further, the carriage 5 is provided with an ink-droplet discharge head 11 and an ink-droplet discharge head driver 322.

Among these elements, the CPU 301 controls the overall operation of the serial inkjet printer 100. The ROM 302 stores a control program such as an initial program loader (IPL) used to drive the CPU 301. The RAM 303 is used as a work area in which the CPU 301 executes a program. The NVRAM 304 stores various kinds of data such as a program, and retains various kinds of data while the power source for the serial inkjet printer 100 is cut out. The external device connection interface 306 is coupled to a personal computer (PC) through, for example, a universal serial bus (USB) cable, and communicates with the PC to exchange the data of an image to be printed or a control signal with the PC. The network interface 309 is an interface for communicating data with an external device through a communication network such as the Internet. The bus line 310 is, for example, an address bus or a data bus, which electrically connects the multiple elements such as the CPU 301 to each other.

The sheet conveyor 311 uses, for example, a roller and a motor used to drive the roller, and conveys a print sheet in the sub-scanning direction along the conveyance path inside the serial inkjet printer 100. The sub-scanning driver 312 controls the movement of the sheet conveyor 333 in the sub-scanning direction, and the main scanning driver 313 controls the movement of the carriage 5 in the main scanning direction.

The ink-droplet discharge head 11 of the carriage 5 has a plurality of nozzles used to discharge droplets of ink or the like, and is mounted on the carriage 5 such that the discharge surface or the face of a nozzle plate faces the top face of a print sheet. The ink-droplet discharge head 11 discharges ink droplets onto a print sheet that is intermittently conveyed in the sub-scanning direction while moving in the main scanning direction. By so doing, ink droplets are discharged onto a desired position of the print sheet and an image is formed. The ink-droplet discharge head driver 322 controls the operation of the ink-droplet discharge head 11.

The operation panel 330 is composed of, for example, a touch panel and an alarm lamp that display, for example, current set values and a panel of options to be selected and accept inputs from an operator.

It is not always necessary for the ink-droplet discharge head driver 322 to be provided for the carriage 5, and the ink-droplet discharge head driver 322 may be coupled to the bus line outside the carriage 5. Each one of the main scanning driver 313, the sub-scanning driver 312, and the ink-droplet discharge head driver 322 may be a function implemented by a command executed by the CPU 301 based on a program.

The serial inkjet printer 100 has a plurality of printing modes so that a user can select a printing mode in consideration of desired image quality or printing speed. The user can select the printing mode in view of, for example, desired image quality, allowable length of printing time, and print media. In the following description, by way of example, the following two printing modes are referred to.

High-speed Printing Mode as First Printing Mode

High-quality Print Mode as Second Printing Mode

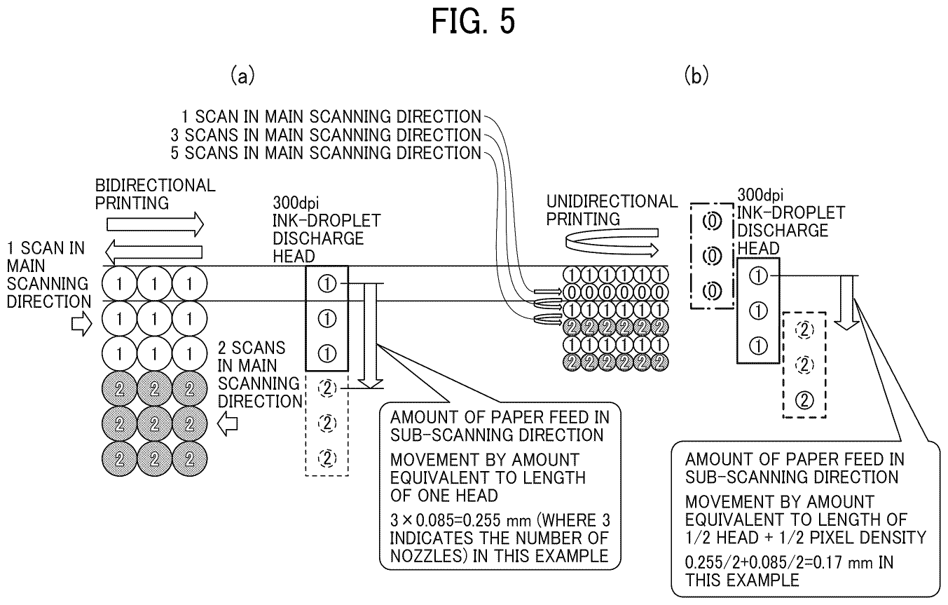

The differences in resolution depending on the printing mode are described below with reference to FIG. 5.

Sub-diagram (a) of FIG. 5 schematically illustrates a resolution in a high-speed printing mode.

Sub-diagram (b) of FIG. 5 schematically illustrates a resolution in a high-quality printing mode.

In FIG. 5, the circled numbers represent the discharged ink droplets, and the ink droplets with the same number represent the ink droplets that are discharged in a one-time scan. As the numbers in circles are greater, those ink droplets are discharged in scanning of a later time.

In FIG. 5, a typical printing mode in which the ink-droplet discharge head 11 with three nozzles of 300 dots per inch (dpi) performs printing is schematically illustrated. The horizontal arrows in FIG. 5 indicate the direction in which the carriage 5 moves in the main scanning direction, and the vertical arrows indicate the direction in which the sheet is conveyed and the amount by which the sheet is conveyed. The position of the ink-droplet discharge head 11 in the vertical direction indicates the relative positions of the ink-droplet discharge head 11 and the printing position when the sheet is conveyed.

The printing speed in the serial inkjet printer 100 is defined as the area of the image that is formed on a recording medium such as a sheet per unit time. Assuming that the specification of the ink-droplet discharge head 11 is equivalent to the speed of paper feed in the sub-scanning direction, the printing speed is determined by the scan rate of the carriage 5, the area of printing per each scan in the main scanning direction, and the amount of intermittent paper feed in the sub-scanning direction. In the first printing mode, i.e., the high-speed printing mode, where priority is given to printing speed, assuming that the pixel density in printing is 300 dpi (main scanning direction)×300 dpi (sub-scanning direction), the scanning speed of the carriage 5 is increased and bidirectional printing is adopted in the main scanning direction, and the amount of intermittent paper feed in the sub-scanning direction is increased by the length of one head in the present embodiment. Accordingly, the serial inkjet printer 100 increases the printing speed, and shortens the length of printing time.

By contrast, in the second printing mode, i.e., the high-quality printing mode, assuming that the pixel density in printing is 600 dpi (main scanning direction)×600 dpi (sub-scanning direction), as the print density is increased, the scanning speed of the carriage 5 is made slower than that in the first printing mode, i.e., a high-speed printing mode. By so doing, high-quality printing is achieved in unidirectional printing. As illustrated in FIG. 5B, the amount of intermittent paper feed in the sub-scanning direction is set to the length corresponding to “½ head+½ pixel density.” As a result, the resolution in the sub-scanning direction is set to 600 dpi.

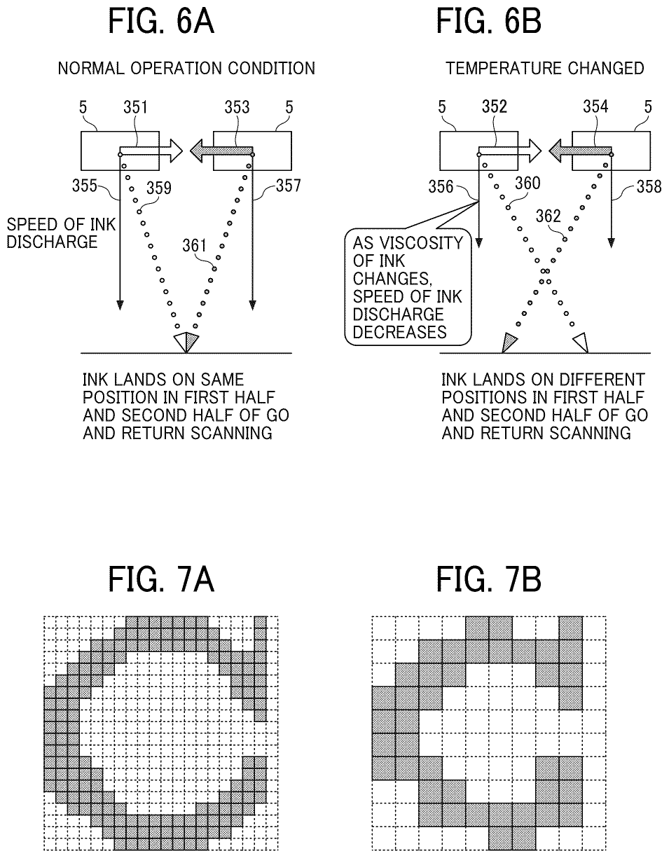

The cause of deterioration in image quality in bidirectional printing is described below with reference to FIG. 6A and FIG. 6B.

FIG. 6A and FIG. 6B are diagrams illustrating misregistration in the landing position of ink in bidirectional printing.

FIG. 6A schematically illustrates a landing position with no misregistration in the landing position of ink.

FIG. 6B schematically illustrates a landing position with misregistration in the landing position of ink.

Arrows 351 and 352 indicate the speed of the carriage 5 in the first half of the go and return scanning, and arrows 353 and 354 indicate the speed of the carriage 5 in the second half of the go and return scanning. Arrows 355 and 356 indicate the speed of ink discharge in the first half of the go and return optical scanning, and arrows 357 and 358 indicate the speed of ink discharge in the second half of the go and return optical scanning. Arrows 359 and 360 indicate the flight path of ink in the first half of the go and return scanning, and arrows 361 and 362 indicate the flight path of ink in the second half of the go and return scanning.

In the bidirectional printing, as illustrated in FIG. 6A and FIG. 6B, the carriage 5 discharges ink in both the first half and second half of the go and return scanning. In order to increase the image quality, it is desired that the landing position of ink between the first half and second half of the go and return scanning not be misaligned. Also in the high-speed printing mode, the speed of ink discharge is adjusted according to the scan rate such that the landing positions of ink will not be misaligned.

However, when the viscosity of the ink changes due to changes in temperature, the speed of ink discharge changes. In other words, when the temperature decreases and the viscosity of the ink increases, the speed of ink discharge decreases. Under such conditions, in bidirectional printing, the landing position of ink may be misaligned on a plane where printing is conducted. In order to handle such a situation, in the high-quality printing mode, the serial inkjet printer 100 increases the precision of the landing position of ink in unidirectional printing to achieve high-quality printing.

However, in the second printing mode, i.e., the high-quality printing mode, compared with the bidirectional printing in the first printing mode, i.e., the high-speed printing mode, the area of printing per each scan in the main scanning direction decreases. Moreover, in order to achieve the pixel density of 600 dpi, the amount of intermittent paper feed in the sub-scanning direction is set to “½ head+½ pixel density.” Accordingly, the amount of intermittent paper feed in the sub-scanning direction decreases compared with the first printing mode, i.e., the high-speed printing mode, and the printing speed decreases and the length of printing time increases.

On the other hand, in terms of the image quality, in the second printing mode, i.e., the high-quality printing mode, the pixel density is doubled in both the main scanning direction and the sub-scanning direction. Accordingly, the resolution increases by four times in total compared with the resolution in the first printing mode, i.e., the high-speed printing mode.

FIG. 7A and FIG. 7B are diagrams illustrating the difference in image quality depending on the printing mode.

More specifically, FIG. 7A illustrates an image in the second printing mode, i.e., the high-quality printing mode, and FIG. 7B illustrates an image in the first printing mode, i.e., the high-speed printing mode.

As illustrated in FIG. 7A and FIG. 7B, the reproducibility of image in the second printing mode, i.e., the high-quality printing mode, is finer than that in the first printing mode, i.e., the high-speed printing mode. In particular, the contour line is smoother and the image quality is better in the second printing mode.

However, the printing speed is reduced to one fourth of the printing speed in the first printing mode, i.e., the high-speed printing mode, under the influence of the speed of the carriage 5, unidirectional printing, and the amount of paper feed in the sub-scanning direction.

In the serial inkjet printer 100 or other non-serial inkjet printers, the ink tends to smear on a sheet, and as illustrated in FIG. 5, the size of ink droplets for one pixel is larger in the first printing mode, i.e., the high-speed printing mode. When the size of ink droplets is large, the ink tends to smear and the image quality may further deteriorate.

### First Embodiment

In order to make full use of large document-size capability, in many cases, the serial inkjet printer 100, which can print image data of a large document size such as A0 or A1, prints an output image of large size. Accordingly, it takes a long time to complete the printing. For this reason, in order to shorten the length of printing time even when the document size is large, in many cases, the default printing mode is set to the first printing mode, i.e., high-speed printing mode.

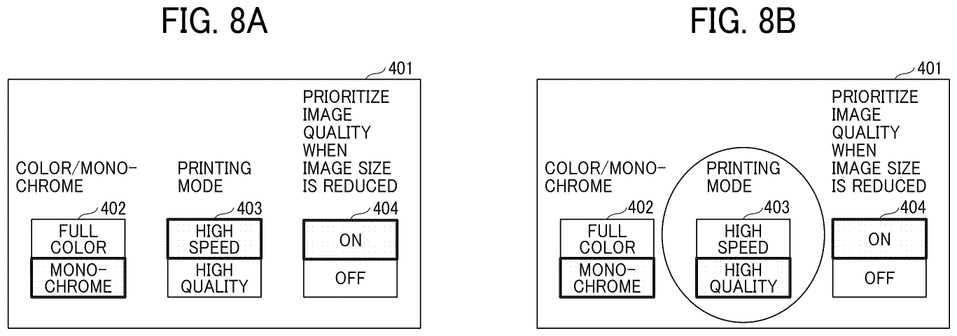

FIG. 8A and FIG. 8B are diagrams each of which illustrates a printing-mode setting screen 401 displayed by the serial inkjet printer 100.

As illustrated in FIG. 8A, the printing-mode setting screen 401 includes a color-or-monochrome setting field 402, a printing-mode setting field 403, and a when-size-reduced image quality mode setting field 404. On the color-or-monochrome setting field 402, full color or monochrome printing can be selected where the default is monochrome printing. When full color that is not the default is selected, the brightness is reduced by half. In the printing-mode setting field 403, one of high speed and high quality can be selected, and the default is high speed. When high quality that is not the default is selected, the brightness is reduced by half. In the when-size-reduced image quality mode setting field 404, one of ON and OFF can be selected. In the present embodiment, when OFF is selected, the brightness is reduced by half. When ON is selected in the when-size-reduced image quality mode setting field 404, the printing mode is automatically selected. On the printing-mode setting screen 401, any desired one of the color-or-monochrome setting field 402, the printing-mode setting field 403, and the when-size-reduced image quality mode setting field 404 may be selected.

In the present embodiment, as illustrated in FIG. 8B, the serial inkjet printer 100 automatically changes the default setting “high speed” in the printing-mode setting field 403 to “high quality” according to the document size and the reduction ratio.

Because a user checks or carries image data of a large document size such as A0 or A1 as in the case of a drawing with a high degree of precision, printing may be conducted using an image reduction unit with a smaller output image such as A3 or A4.

In the present embodiment, the reduction ratio is defined as follows.

Reduction Ratio=Image Size of Output Image/Document Size of Image Data

For example, when A1 image data (841 mm×594 mm) is printed with A3 size (420 mm×297 mm), the reduction ratio is about 0.5 as a result of calculation 420 mm/841 mm or 297 mm/594 mm. For example, when A1 image data (841 mm×594 mm) is printed with A2 size (594 mm×420 mm), the reduction ratio is about 0.71 as a result of calculation 594 mm/841 mm or 420 mm/594 mm. As the reduction ratio is smaller, the size of the printed output image gets smaller with respect to the original document size.

When the serial inkjet printer 100 conducts printing with the image data reduced, the size of texts decreases and the lines get thinner relative to the original size or original lines. Accordingly, when printing is conducted by default in the first printing mode, i.e., the high-speed printing mode, the image quality significantly deteriorates, and the definition of texts is lost and the reproducibility of lines deteriorates.

When printing is conducted with the image data reduced, in consideration of image quality, a user may change the default of the first printing mode, i.e., the high-speed printing mode, to the second printing mode, i.e., the high-quality printing mode. However, when printing is conducted by default, desired image quality is not achieved, and there may be the need for re-printing in which printing is conducted again with the image data reduced and the printing mode is switched to the second printing mode, i.e., the high-quality printing mode.

In order to handle such a situation, when the serial inkjet printer 100 conducts printing with the image data reduced in the present embodiment, the first printing mode, i.e., high-speed printing mode, is switching to the second printing mode, i.e., the high-quality printing mode, based on the obtained document size and reduction ratio.

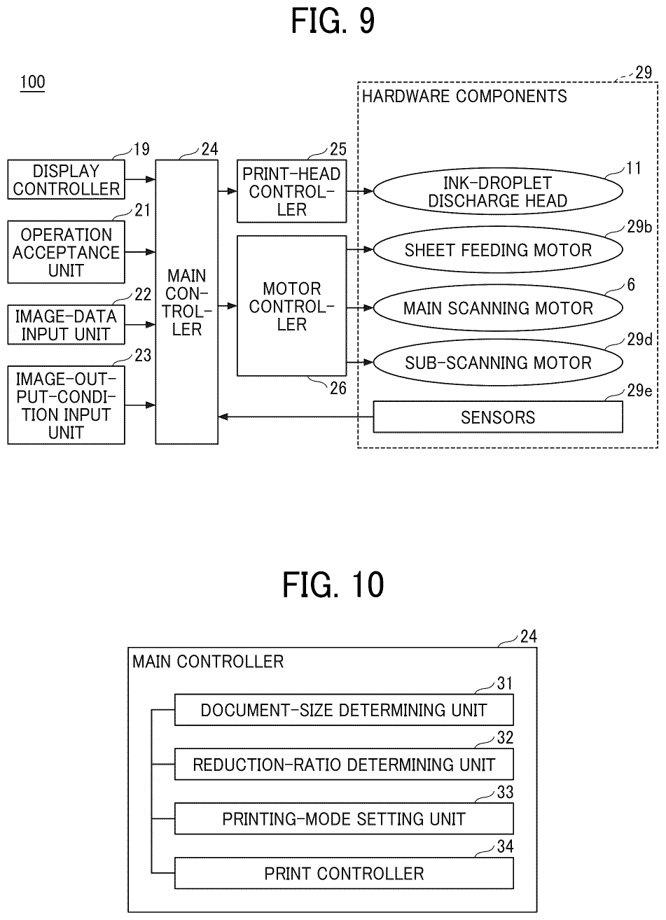

FIG. 9 is a functional block diagram of the serial inkjet printer 100.

The serial inkjet printer 100 includes a display controller 19, an operation acceptance unit 21, an image-data input unit 22, an image-output-condition input unit 23, a main controller 24, a print-head controller 25, and a motor controller 26. For the sake of explanatory convenience, the ink-droplet discharge head 11, a sheet feeding motor 29b, the main-scanning motor 6, a sub-scanning motor 29d, and a plurality of sensors 29e that make up hardware components 29 are also illustrated.

The main controller 24 performs overall control on the serial inkjet printer 100. The main controller 24 selects an appropriate printing mode based on the obtained document size and reduction ratio. For example, the main controller 24 switches the first printing mode, i.e., high-speed printing mode, to the second printing mode, i.e., the high-quality printing mode, based on the obtained document size and reduction ratio.

The display controller 19 causes the operation panel 330 to display an operation screen such as a printing-mode setting screen 401 as will be described later in detail, which serves as a user interface (UI). When an image is to be printed, the operation acceptance unit 21 receives, for example, a print job that is a file or set of files to be printed or instructions to start printing. The operation acceptance unit 21 receives the setting made on the printing-mode setting screen 401 including the color-or-monochrome setting field 402, the printing-mode setting field 403, and the when-size-reduced image quality mode setting field 404 as illustrated in FIG. 8A and FIG. 8B.

The image-data input unit 22 obtains the document size such as A0 and A1 of image data to be printed and the image size of an output image to be printed, based on the print job specified by a user.

The image-output-condition input unit 23 obtains the information about the currently-set printing mode, and calculates a reduction ratio based on the document size of the image data and the image size of an output image.

The main controller 24 controls the print-head controller 25 and the motor controller 26. The print-head controller 25 controls the ink-droplet discharge head 11 to discharge ink in accordance with the printing mode. The motor controller 26 controls a plurality of motors to operate the carriage 5 and convey a sheet.

FIG. 10 is a functional block diagram of the main controller 24.

The main controller 24 includes a document-size determining unit 31, a reduction-ratio determining unit 32, a printing-mode setting unit 33, and a print controller 34.

The document-size determining unit 31 determines whether the document size of the image data is equal to or greater than the threshold. The threshold may be a fixed value such as A0, but may be set by the user (see the second embodiment).

The reduction ration is obtained by dividing the image size of an output image by the document size of the image data, and the reduction-ratio determining unit 32 determines whether the reduction ratio is equal to or smaller than the threshold. The threshold may be a fixed value such as 0.5, but may be set by the user (see the second embodiment).

When the document size is equal to or larger than a threshold and the reduction ratio is equal to or smaller than a threshold, the printing-mode setting unit 33 sets the printing mode of the serial inkjet printer 100 to the high-quality printing mode. When these conditions are not met, the printing-mode setting unit 33 sets the printing mode to the high-speed printing mode. In other words, the printing-mode setting unit 33 selects the printing mode according to the result of comparison of the document size of the image data with the threshold and the result of comparison of the reduction ratio with the threshold.

The print controller 34 downsizes the image data at a selected reduction ratio in the printing mode selected by the printing-mode setting unit 33 to print an output image.

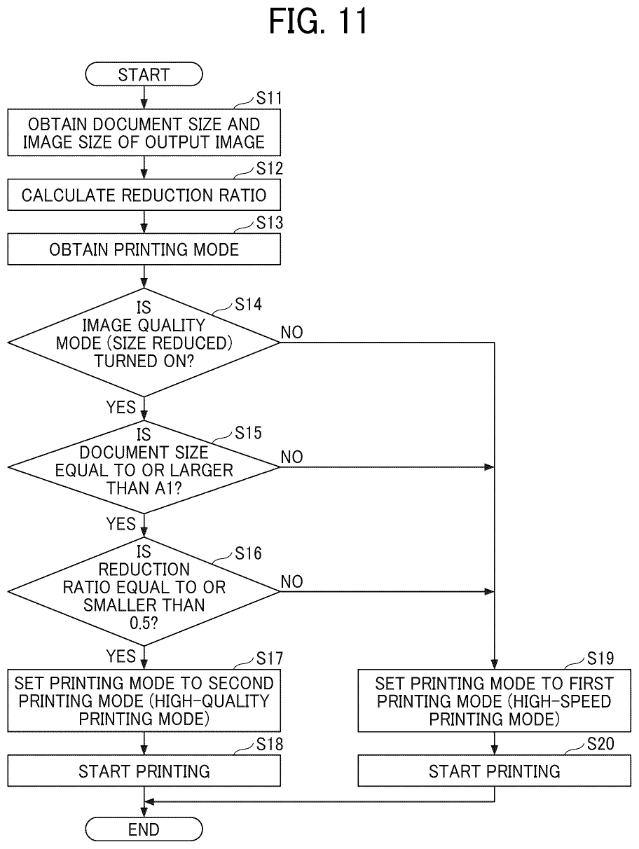

FIG. 11 is a flowchart of controlling processes in which the main controller 24 automatically selects a printing mode when the size is to be reduced in printing.

In step S11, the image-data input unit 22 obtains, from the print job, the document size of the image data to be printed and the image size of an output image.

Then, in step S12, the image-output-condition input unit 23 calculates a reduction ratio based on the document size of the image data and the image size of an output image.

Subsequently, in step S13, the image-output-condition input unit 23 obtains the current printing mode. As the current printing mode is used for the determination of switching, it is not always necessary to obtain the current printing mode.

Subsequently, in step S14, the main controller 24 determines whether ON is selected in the when-size-reduced image quality mode setting field 404. When the determination in step S14 is YES, the process proceeds to step S15. When the determination in step S14 is NO, the process proceeds to step S19.

In step S15, the document-size determining unit 31 determines whether the document size is equal to or larger than A1. A1 is an example of a large document size, and may be compared with A0 or A2.

When the determination in step S15 is YES, the process proceeds to step S16. When the determination in step S15 is NO, the process proceeds to step S19.

In step S16, the reduction-ratio determining unit 32 determines whether the reduction ratio is equal to or smaller than 0.5.

0.5 is an example of a small reduction ratio, and the threshold may be any desired value other than 0.5.

When the determination in step S16 is YES, the process proceeds to step S17. When the determination in step S16 is NO, the process proceeds to step S19.

In step S17, the printing-mode setting unit 33 sets the printing mode to the high-quality printing mode. In the high-quality printing mode, the size of the ink droplets is reduced, and the scanning density in the main scanning direction and the sub-scanning direction is increased.

In step S18, the print controller 34 of the main controller 24 controls the print-head controller 25 and the motor controller 26 to start printing in the high-quality printing mode. The print controller 34 downsizes the image data at a selected reduction ratio to print an output image.

As the document size is smaller than A1 or the reduction ratio is not small, in step S19, the printing-mode setting unit 33 sets the printing mode to the high-speed printing mode.

In step S20, the print controller 34 controls the print-head controller 25 and the motor controller 26 to start printing using the high-speed printing mode. The print controller 34 downsizes the image data at a selected reduction ratio to print an output image.

As described above, each of the document size and the reduction ratio is compared with a threshold to select a printing mode. As only a single factor of a large document size does not degrade image quality, the serial inkjet printer 100 can use the high-speed printing mode to prevent the length of printing time from becoming long. In a similar manner, as only a single factor of a small reduction ratio does not degrade image quality, the serial inkjet printer 100 can use the high-speed printing mode to prevent the length of printing time from becoming long. For this reason, each of the document size and the reduction ratio is compared with a threshold to select a printing mode. Accordingly, when there is a high probability that the image quality degrades, printing can be conducted in the high-quality printing mode.

Due to the controlling processes as described above, even if image data is printed with a reduced size, the printing mode is automatically switched to the second printing mode, i.e., the high-quality printing mode and the printing is conducted as long as ON is selected in the when-size-reduced image quality mode setting field 404. Accordingly, even when the reduction ratio is decreased and image data is to be printed with a large document size, the image quality does not deteriorate, and the necessity of re-printing can be reduced.

When image data of a large document size is to be printed, the length of printing time in the second printing mode, i.e., the high-quality printing mode, tends to be long. However, for example, when an A1 image is printed at the reduction ratio of 0.5, the image size to be printed is A3, and the length of printing time for an A3 image is not too long and allowable even in the high-quality printing mode.

As described above, when the second printing mode, i.e., the high-quality printing mode, is selected in cases where the reduction ratio with respect to the image size is large and not much reduction is made, the image size to be printed is large, and the image does not easily degrade. However, the length of printing time tends to increase. However, in the present embodiment, even when ON is selected in the when-size-reduced image quality mode setting field 404, it is determined to be NO in step S14 or step S15. By so doing, printing is conducted in the first printing mode, i.e., the high-speed printing mode, to prevent the length of printing time from becoming long.

Simple image data such as an illustration does not degrade in image quality even when image data of a large document size is downsized in printing. Accordingly, there are some cases where printing in the first printing mode, i.e., the high-speed printing mode, does not cause much trouble in use. In such cases, the user may turn off the setting of the when-size-reduced image quality mode setting field 404.

### Second Embodiment

The image quality and the allowable length of printing time that a user requires vary depending on who the user is or the situation of the user. For example, when an image is to be downsized in printing, the user may wish to shorten the length of printing time slightly while maintaining a high quality or higher resolution. For example, when the document size is to be downsized in printing from A1 to A2 at a reduction ratio of 0.71, the image size of an output image to be printed is large compared with a case in which the document size is downsized in printing from A1 to A3 at a reduction ratio of 0.5. However, A2 provides a higher image quality and requires a shorter printing time than A1. In order to handle such a situation, the serial inkjet printer 100 according to the present embodiment adopts a third printing mode, i.e., the standard printing mode.

In terms of the printing speed and image quality, the third printing mode, i.e., the standard printing mode is defined as follows.

### Printing Speed

First printing mode (high-speed printing mode)>Third printing mode (standard printing mode)>Second printing mode (high-quality printing mode)

### Image Quality

Second printing mode (high-quality printing mode)>Third printing mode (standard printing mode)>First printing mode (high-speed printing mode)

When printing is conducted with the image data reduced, the serial inkjet printer 100 selects one of the three printing modes based on the obtained document size and reduction ratio.

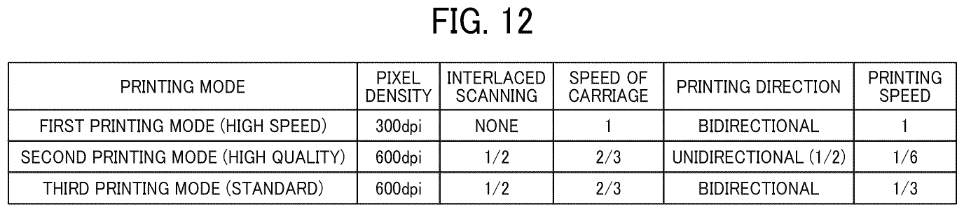

FIG. 12 is a diagram depicting the details of three printing modes.

The third printing mode, i.e., the standard printing mode, has the following properties or characteristics.

Compared with the second printing mode, i.e., the high-quality printing mode, the unidirectional printing in the main scanning direction is changed to the bidirectional printing.

Compared with the first printing mode, i.e., the high-speed printing mode, the image quality is superior, but the printing speed is slower.

Compared with the second printing mode, i.e., the high-quality printing mode, the image quality is inferior, but the printing speed is faster.

As illustrated in FIG. 5, in the interlaced scanning, the amount of paper feed in the sub-scanning direction is set to the movement corresponding to the length of “½ head+½ pixel density,” and the print density in the sub-scanning direction is increased from 300 dpi to 600 dpi. Accordingly, the amount of paper feed in the third printing mode, i.e., the standard printing mode is about half of the amount of paper feed in the first printing mode, i.e., the high-speed printing mode.

As illustrated in FIG. 12, the speed of the carriage 5 in the second and third printing modes is ⅔ of the speed of the carriage 5 in the first printing mode, i.e., a high-speed printing mode. When printing is conducted in one direction, the printing speed is ½ of that in the bidirectional printing. Accordingly, in terms of the area, the printing speed in the second printing mode is ⅙ of that in the first printing mode, i.e., the high-speed printing mode, and the printing speed in the third printing mode is ⅓ of that in the first printing mode, i.e., the high-speed printing mode.

As the degree of deterioration of an image when the size of the image is to be reduced varies depending on, for example, the type of image and whether the image is in color or monochrome, it is desired the conditions for the document size and the reduction ratio, which are used to change the printing mode, vary depending on the type of image and whether the image is in color or monochrome.

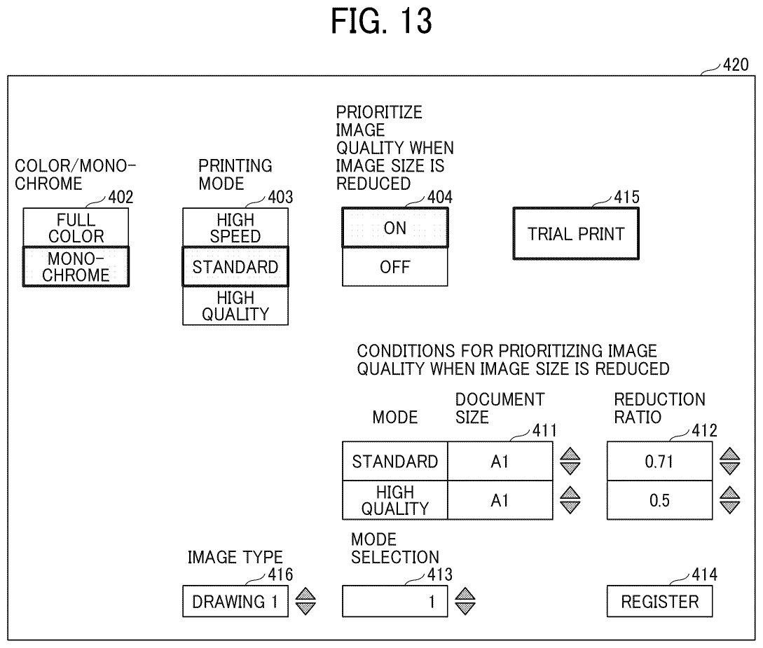

In order to achieve such functions, as illustrated in FIG. 13, it is desired that various kinds of thresholds be adjustable.

FIG. 13 is a diagram illustrating a printing-mode setting screen.

In the description of FIG. 13, the differences from FIG. 8A and FIG. 8B are described. In addition to the printing-mode setting screen 401 of FIG. 8A and FIG. 8B, the printing-mode setting screen 420 includes a document-size setting field 411, a reduction-ratio setting field 412, an image-type selection field 416, a mode selection field 413, a trial print key 415, and a registration key 414.

As the third printing mode is added, the printing-mode setting field 403 on the printing-mode setting screen 420 of FIG. 13 accepts three printing modes including a high-speed printing mode, a standard printing mode, and a high-quality printing mode.

For each one of the standard printing mode and the high-quality printing mode, the threshold to be compared with the original document size is adjustable in the document-size setting field 411. When the document size of the image data is equal to or larger than a threshold associated with the standard printing mode, the printing may be conducted in the standard printing mode (further determination is made depending on the reduction ratio). When the document size of the image data is equal to or larger than a threshold associated with the high-quality printing mode, the printing may be performed in the high-quality printing mode (further determination is made depending on the reduction ratio).

In a similar manner, for each one of the standard printing mode and the high-quality printing mode, the threshold to be compared with the original document size is selectable in the reduction-ratio setting field 412. When the reduction ratio in printing is equal to or smaller than a threshold associated with the standard printing mode and is equal to or greater than a threshold associated with the high-quality printing mode, the printing is performed in a standard printing mode. When the reduction ratio in printing is equal to or smaller than a threshold associated with the high-quality printing mode, the printing is performed in the high-quality printing mode. The threshold that is associated with the standard printing mode in the reduction-ratio setting field 412 is an example of a third threshold.

As described above, the user can freely change the conditions for the document size and the reduction ratio, which are used to change the printing mode, in view of, for example, the image type or whether color printing or monochrome printing is to be conducted.

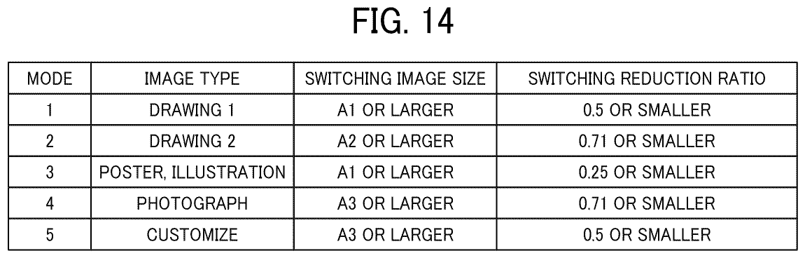

The image-type selection field 416 and the mode selection field 413 accept the selection of preset thresholds to be compared with the document size and the reduction ratio. The preset thresholds will be described below with reference to FIG. 14. A user uses the up and down keys on the right side of the image-type selection field 416 to switch the image types. Because the preset threshold values are appropriately set according to the image type, a user can set thresholds to be compared with the document size and the reduction ratio simply by selecting the image type or mode. The user can also switch the mode using the up and down keys on the right side of the mode selection field 413. Each mode is represented by, for example, a number. Each mode is associated with an image type, and the displays of the mode selection field 413 and the image-type selection field 416 switch in synchronization with each other. A user who knows the threshold set in the mode can select the mode, and a user who wants to set the threshold by the image type may select the image type.

The trial print key 415 is a key or button to accept an operation to request a trial print on the printing-mode setting screen 420 of FIG. 13. When the trial print key 415 is touched or clicked, the print controller 34 prints only the area of the image data determined by the minimum amount of paper feed in the sub-scanning direction.

The registration key 414 accepts a command to apply the thresholds selected in the document-size setting field 411 and the reduction-ratio setting field 412 to the serial inkjet printer 100. The thresholds that are applied through the registration key 414 are selectable as a customized setting in the image-type selection field 416. As described above, a user can select any desired switching image size and switching reduction ratio. As the thresholds that are selected as desired by a user are stored, those thresholds can easily be retrieved and used whenever necessary without the need for selecting thresholds again at the time of printing.

As illustrated in FIG. 13, even if the condition or threshold for switching the printing mode is editable in the when-size-reduced image quality mode, some users do not know how to appropriately edit such a condition or threshold for switching the printing mode. In such cases, it is convenient if the condition for switching the printing mode in the when-size-reduced image quality mode is determined in advance for every image type.

FIG. 14 is a table depicting conditions for switching the printing mode in the when-size-reduced image quality mode.

In FIG. 14, for varying image types, switching image sizes and switching reduction ratios are associated with each other. In FIG. 14, MODE indicates data identifying each image type, and IMAGE TYPE is classified into, for example, a drawing, poster, illustration, or photograph. Due to such a configuration, desired switching image size and switching reduction ratio can be selected by selecting the image type of the image to be printed on the printing-mode setting screen 420 of FIG. 13.

In FIG. 14, a “customized setting” is arranged in the lowest cell of the IMAGE TYPE column. The “customized setting” includes the thresholds, i.e., a switching image size and switching reduction ratio, selected in the document-size setting field 411 and the reduction-ratio setting field 412 on the printing-mode setting screen 420 of FIG. 13. Due to such a configuration, a user can select a customized switching image size and switching reduction ratio.

When the image type or the mode is selected on the printing-mode setting screen 420 of FIG. 13, the standard printing mode is not selected. This is because there is only one switching reduction ratio in the present embodiment described with reference to FIG. 14. However, no limitation is indicated thereby, and a pair of switching reduction ratios may be arranged in advance for each one of the image types in the present embodiment described with reference to FIG. 14, such that the standard printing mode will be selected when an image type or mode is selected by a user.

Both when the document size is to be downsized in printing from A1 to A2 at a reduction ratio of 0.71 and when the document size is downsized in printing from A1 to A3 at a reduction ratio of 0.5, there are some cases where a finished quality is to be checked with a minimum undesired use of sheet or ink. In such cases, when the trial print key 415 is touched or clicked on the printing-mode setting screen 420, the print controller 34 uses the printing mode determined by the thresholds selected in the document-size setting field 411 and the reduction-ratio setting field 412 to perform the printing of image data with the range that corresponds to the minimum amount of paper feed in the sub-scanning direction. Accordingly, a finished quality can be checked with a minimum undesired use of sheet or ink.

When the serial inkjet printer 100 performs printing using a roll sheet, the width of the sheet is the width of a roll sheet selected by a user. In the present embodiment, the width of a roll sheet is 420 mm. When the document size is to be downsized in printing from A1 to A2 at a reduction ratio of 0.71, the image size of an output image is 420 mm×594 mm (width×length). When the document size is to be downsized in printing from A1 to A3 at a reduction ratio of 0.5, the image size of an output image is 420 mm×297 mm (width×length).

The minimum amount of paper feed in the sub-scanning direction is determined by the configuration or structure of the serial inkjet printer 100. For example, when it is assumed that the minimum amount of paper feed in printing is 210 mm, the minimum printable output size when a roll sheet whose width is 420 mm is selected is 420 mm (width)×210 mm (length).

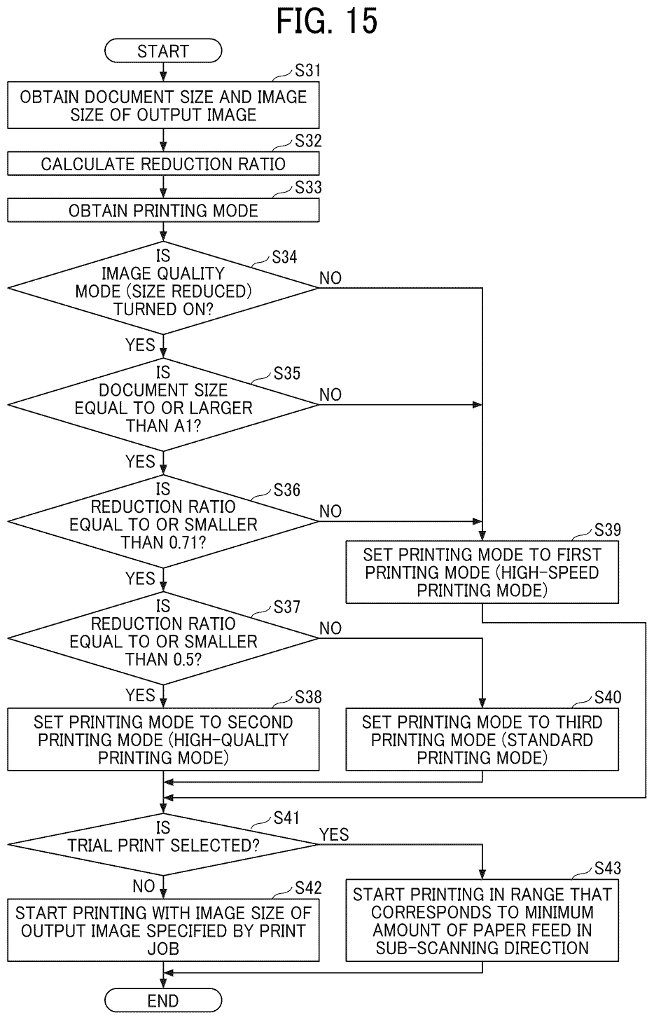

FIG. 15 is a flowchart of controlling processes in which the main controller 24 automatically selects a printing mode when the size is to be reduced in printing.

In the description of FIG. 15, only the differences from the processes in FIG. 11 may be described. FIG. 15 is different from FIG. 11 in that a step S36 is added. In other words, the third printing mode, i.e., the standard printing mode, is prepared in the present embodiment, and the printing mode is selected according to the document size and the reduction ratio that are set to select the third printing mode, i.e., the standard printing mode. For example, in step S36, the reduction-ratio determining unit 32 determines whether the reduction ratio is equal to or smaller than 0.71. 0.71 is an example of the third threshold.

When the determination in step S36 is YES, the process proceeds to step S37. When the determination in step S36 is NO, the process proceeds to step S39.

In step S37, the reduction-ratio determining unit 32 determines whether the reduction ratio is equal to or smaller than 0.5. When the determination in step S37 is YES, the process proceeds to step S38. When the determination in step S37 is NO, the process proceeds to step S40.

In step S38, the printing-mode setting unit 33 selects the second printing mode, i.e., the high-quality printing mode. In step S40, the printing-mode setting unit 33 selects the third printing mode, i.e., the standard printing mode. In step S39, the printing-mode setting unit 33 selects the first printing mode, i.e., the high-quality printing mode.

After steps S38 to S40, the process proceeds to step S41. In step S41, the main controller 24 determines whether the trial print key 415 has been touched or clicked. When the determination in step S41 is YES, the process proceeds to step S43. When the determination in step S41 is NO, the process proceeds to step S42.

In step S42, the print controller 34 starts printing with the image size of the output image specified by a print job. In step S43, the print controller 34 starts printing in the range that corresponds to the minimum amount of paper feed in the sub-scanning direction.

When the trial print key 415 is touched or clicked, the output image is printed with the minimum amount of paper feed in the sub-scanning direction. Accordingly, the length of the image data to be printed is shortened in the sub-scanning direction compared with A2 or A3, and the area of printing also decreases. Due to such a configuration, a finished quality can be checked with a minimum undesired use of sheet or ink.

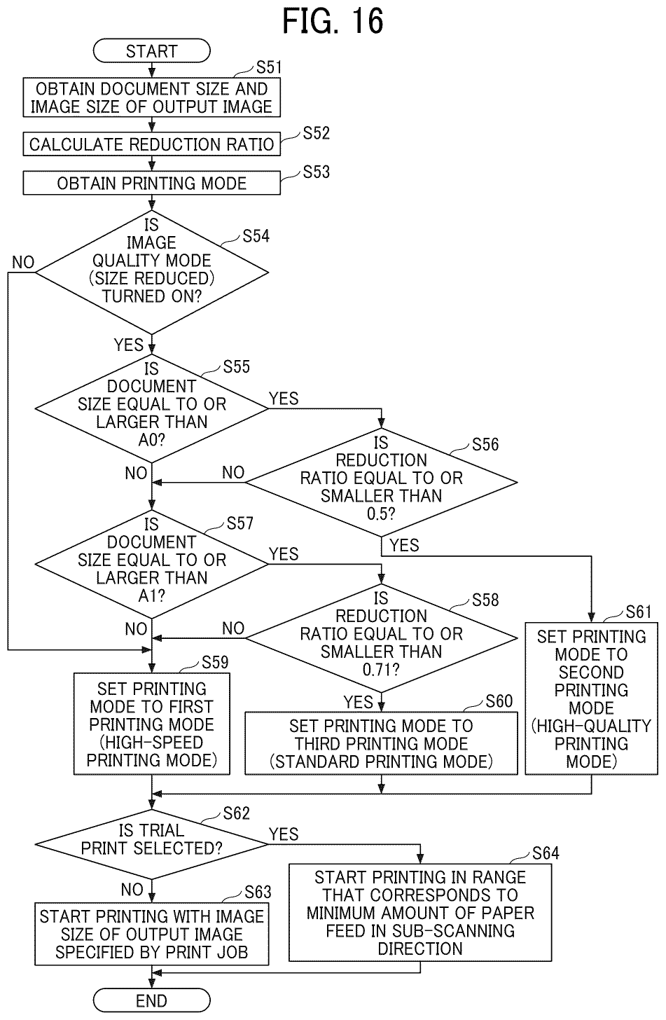

In FIG. 15, A1 is only the threshold to be compared with the original document size. Cases in which the thresholds of both the document size and the reduction ratio are different between the standard printing mode and the high-quality printing mode are described with reference to FIG. 16.

FIG. 16 is a flowchart of controlling processes in which the main controller 24 automatically selects a printing mode when the size is to be reduced in printing.

In the description of FIG. 16, only the differences from the processes in FIG. 11 may be described. The processes in steps S51 to S54 in FIG. 16 are equivalent to the processes in steps S31 to S34 in FIG. 15, respectively.

In step S55, the document-size determining unit 31 determines whether the document size is equal to or larger than A0. A0 is an example of the threshold of the high-quality printing mode set by the user.

When the determination in step S55 is YES, the process proceeds to step S56. When the determination in step S55 is NO, the process proceeds to step S57.

In step S56, the reduction-ratio determining unit 32 determines whether the reduction ratio is equal to or smaller than 0.5. 0.5 is an example of the threshold of the high-quality printing mode set by the user.

When the determination in step S56 is YES, the process proceeds to step S61. When the determination in step S56 is NO, the process proceeds to step S57. In step S61, the printing-mode setting unit 33 selects the second printing mode, i.e., the high-quality printing mode. As described above, the high-quality printing mode is selected based on a threshold set by a user for the high-quality printing mode.

Subsequently, in step S57, the document-size determining unit 31 determines whether the document size is equal to or larger than A1. A1 is an example of the fourth threshold of the standard printing mode set by the user.

When the determination in step S57 is YES, the process proceeds to step S58. When the determination in step S57 is NO, the process proceeds to step S59.

In step S58, the reduction-ratio determining unit 32 determines whether the reduction ratio is equal to or smaller than 0.71.

0.71 is an example of the third threshold of the standard printing mode set by the user.

When the determination in step S58 is YES, the process proceeds to step S60. When the determination in step S58 is NO, the process proceeds to step S59. In step S60, the printing-mode setting unit 33 sets the printing mode to the third printing mode, i.e., the standard printing mode. As described above, the standard printing mode is selected based on a threshold set by a user for the standard printing mode.

In step S59, the printing-mode setting unit 33 sets the printing mode to the first printing mode, i.e., the high-speed printing mode. The processes in steps S62 to S64 in FIG. 16 are equivalent to the processes in steps S41 to S43 in FIG. 15, respectively.

As described above, even when different thresholds are selected for the document size and the reduction ratio in both the standard printing mode and the high-quality printing mode, an appropriate printing mode is selected by making a comparison in advance between the thresholds set in the high-quality printing mode and the document size and the reduction ratio.

As described above, with the serial inkjet printer 100 of the present embodiment and the use of the third printing mode, in addition to the advantageous effects achieved in the first embodiment, when the size is to be reduced in printing, the length of printing time can slightly be shortened while maintaining a high image quality. Any desired thresholds may be set, and the thresholds that are specified by a user can be retrieved later on. Moreover, a user can select any one of the preset thresholds based on the image type or the mode.

### Third Embodiment

In the first and second embodiments, the serial inkjet printer 100 determines the printing mode. However, no limitation is indicated thereby, and for example, the terminal device 50 or a server that can communicate with the serial inkjet printer 100 may determine the printing mode.

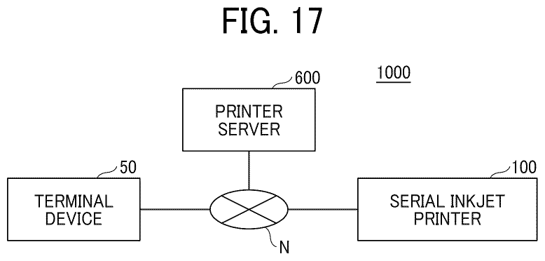

FIG. 17 is a diagram illustrating a system configuration of the printing system 1000.

In the printing system 1000 illustrated in FIG. 17, the terminal device 50, a printer server 600, and the serial inkjet printer 100 are connected to each other and can communicate with each other through a communication network N. The communication network N may be a wired local area network (LAN) or a wireless local area network (LAN). The printer server 600 may be on the cloud network or on-premises equipment. The printer server 600 receives a print job from the terminal device 50, and applies the received print job in view of the status of the serial inkjet printer 100.

The terminal device 50 receives an operation that requests the execution of a print job, through an information processing terminal that a user operates. A printer driver operates in the terminal device 50, and the printer driver can communicate with the serial inkjet printer 100 or the printer server 600. The terminal device 50 may be, for example, a personal computer (PC), a tablet PC, or a smartphone.

In such a configuration, the terminal device 50 or the printer server 600 can instruct the serial inkjet printer 100 to change the printing mode. It is assumed in the present embodiment that the terminal device 50 gives instructions in regard to the printing mode.

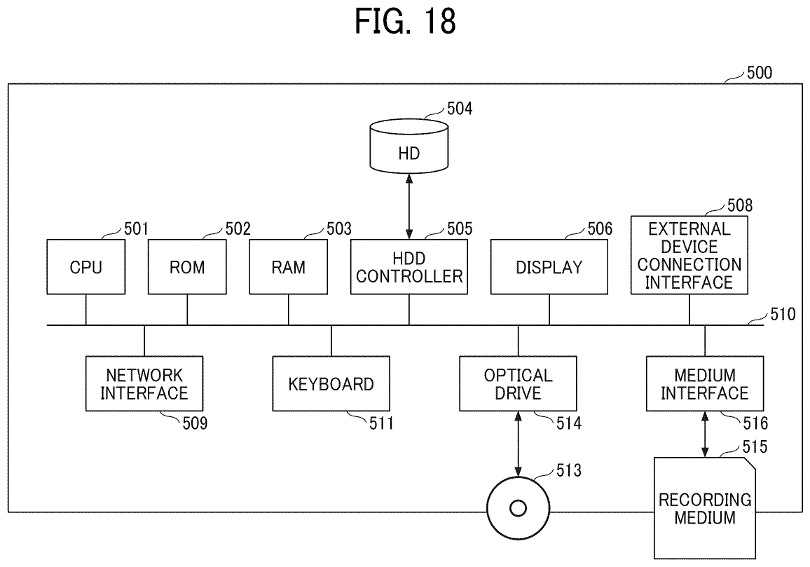

FIG. 18 is a block diagram illustrating a hardware configuration of the terminal device 50.

As illustrated in FIG. 18, the terminal device 50 is configured by a computer 500, and is provided with a central processing unit (CPU) 501, a read-only memory (ROM) 502, a random-access memory (RAM) 503, hard disk (HD) 504, a hard disk drive (HDD) controller 505, a display 506, an external device connection interface 508, a network interface 509, a bus line 510, a keyboard 511, an optical drive 514, and a medium interface 516.

Among these elements, the CPU 501 controls the overall operation of the terminal device 50. The ROM 502 stores a control program such as an initial program loader (IPL) used to drive the CPU 501. The RAM 503 is used as a work area for the CPU 501. The HD 504 stores various kinds of data such as a program. The HDD controller 505 controls the reading or writing of various kinds of data to or from the HD 504 under the control of the CPU 501. The display 506 displays various kinds of information such as a cursor, menu, window, text, or image. The external device connection interface 508 is an interface circuit that connects the above devices or systems to various kinds of external devices. The external devices in the present embodiment may be, for example, a universal serial bus (USB) memory and a printer. The network interface 509 controls data communication with an external device through the network. The bus line 510 is, for example, an address bus or a data bus, which electrically connects various elements such as the CPU 501 illustrated in FIG. 18.

The keyboard 511 is one example of an input device provided with a plurality of keys used to input, for example, texts, numerical values, and various kinds of instructions. The optical drive 514 reads or writes various kinds of data on an optical recording medium 513, which is one example of a removable recording medium. The optical recording medium 513 may be, for example, a compact disk (CD), a digital versatile disk (DVD), or a BLU RAY. The medium interface 516 controls the reading or writing of data to or from a recording medium 515 such as a flash memory.

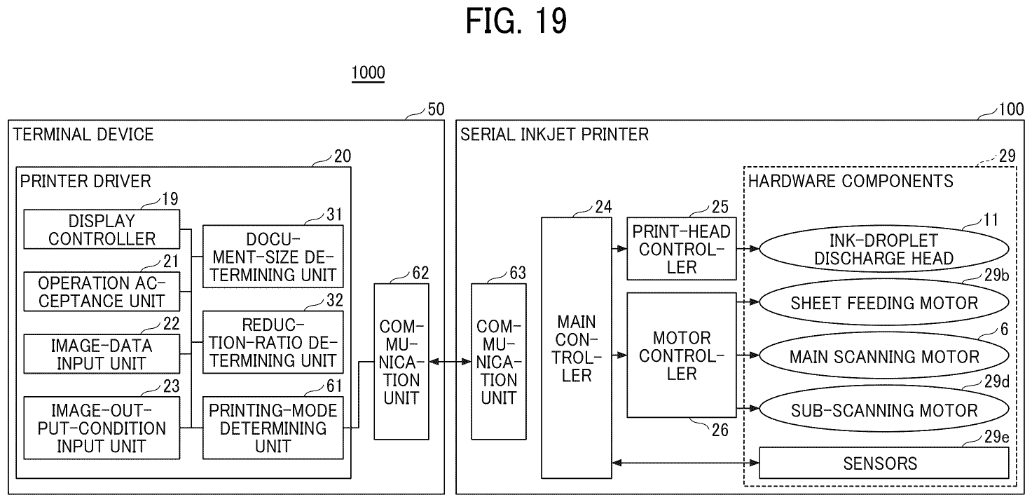

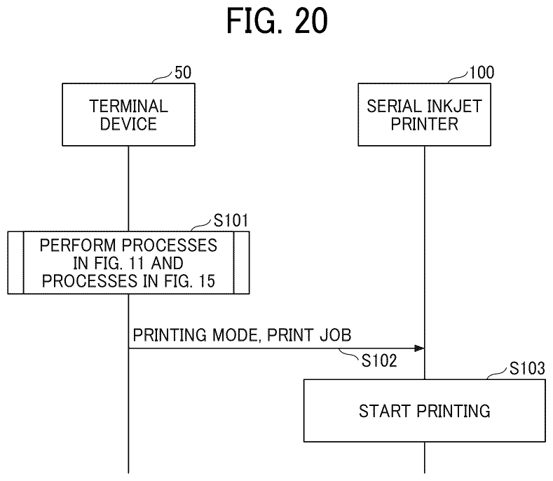

FIG. 19 is a diagram illustrating functional blocks of the terminal device 50 and the serial inkjet printer 100 in the printing system 1000.

The terminal device 50 includes a printer driver 20 and a communication unit 62. The printer driver 20 further includes a display controller 19, an operation acceptance unit 21, an image-data input unit 22, an image-output-condition input unit 23, the document-size determining unit 31, the reduction-ratio determining unit 32, and a printing-mode determining unit 61. The functions of the display controller 19, the operation acceptance unit 21, the image-data input unit 22, the image-output-condition input unit 23, the document-size determining unit 31, and the reduction-ratio determining unit 32 are similar to those of the first or second embodiment. When the size is to be reduced in printing, the printing-mode determining unit 61 determines the printing mode according to the document size and the reduction ratio. A determination method is similar to that of the first or second embodiment. The communication unit 62 of the terminal device 50 sends the printing mode and the print job determined by the printing-mode determining unit 61 to the serial inkjet printer 100.

The serial inkjet printer 100 includes a communication unit 63, a main controller 24, a print-head controller 25, a motor controller 26, and hardware components 29. The main controller 24, the print-head controller 25, the motor controller 26, and the hardware components 29 are similar to those of the first or second embodiment. However, the main controller 24 does not have to determine the printing mode according to the document size and the reduction ratio. This is because the communication unit 63 of the serial inkjet printer 100 receives a printing mode from the terminal device 50.

In the present embodiment, the printing-mode determining unit 61 determines the printing mode according to the document size and the reduction ratio as in the flowchart of FIG. 11 or FIG. 15. The communication unit 62 of the terminal device 50 sends the determined printing mode to the serial inkjet printer 100, such that the main controller 24 receives the sent printing mode. Accordingly, advantageous effects similar to those of the first or second embodiment can be achieved.

FIG. 20 is a data sequence diagram illustrating the processes of printing image data of a large document size in a reduced size by the printing system 1000.

In step S101, the document-size determining unit 31, the reduction-ratio determining unit 32, and the printing-mode determining unit 61 of the terminal device 50 determines the printing mode as in the flowchart of the first or second embodiment described above with reference to FIG. 11 or FIG. 15.

In step S102, the communication unit 62 of the terminal device 50 sends the printing mode and the print job to the serial inkjet printer 100.

In step S103, the communication unit 63 of the serial inkjet printer 100 receives the printing mode and the print job, and the main controller 24 starts printing in accordance with the received printing mode.

As the printer driver 20 determines the printing mode, in addition to the advantageous effects achieved in the first and second embodiments, the printing system 1000 can reduce the load on the serial inkjet printer 100.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

In the present embodiment, each of the document size and the reduction ratio is compared with a threshold to select a printing mode. However, no limitation is indicated thereby, and for example, the printing mode may be selected based on only the reduction ratio. Such a control is beneficial in the serial inkjet printer 100 where the image quality degrades when the reduction ratio is small even if the document size is small.

In the present embodiment, the serial inkjet printer 100 is described. However, no limitation is intended thereby, and a line inkjet printer may be adopted. An ink-droplet discharge head whose length is equivalent to the page width is fixed to such a line inkjet printer, and the line inkjet printer feeds a sheet in the sub-scanning direction without performing scanning in the main scanning direction.

In the present embodiment, the serial inkjet printer 100 changes the printing mode when the size is to be reduced in printing. However, no limitation is indicated thereby, and the printing mode may be changed when the size is to be increased in printing. It takes a long time to complete the printing when the size is to be increased in printing. For this reason, for example, when the document size is equal to or smaller than a threshold and/or the magnifying power is equal to or greater than a threshold, the serial inkjet printer 100 selects the high-speed printing mode.

In the embodiments described with reference to, for example, FIG. 9 and FIG. 10, the processing is divided into some major functions to facilitate the understanding of the processing of the serial inkjet printer 100. The embodiments of the present disclosure are not limited by how the processing is divided into processing units or by the names of the units. The processing of the serial inkjet printer 100 may be divided into a larger number of processing units depending on the detail of the processing of the serial inkjet printer 100. Such division may be made such that one processing unit includes a larger number of processes.

Each of the functions of the described embodiments of the present disclosure may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions. The one or more processing circuits herein includes, for example, devices such as a processor that is programmed to execute software to implement functions, like a processor with electronic circuits, an application-specific integrated circuit (ASIC) that is designed to execute the above functions, a digital signal processor (DSP), a field-programmable gate array (FPGA), and circuit modules or circuit components known in the art arranged to perform the recited functions.

### Aspects

### First Aspect

A serial inkjet printer, which can print image data upon reducing the image data to an output image smaller than a document size of the image data, includes a printing-mode setting unit to select a printing mode according to a result of comparison of the document size with a first threshold and a result of comparison of a reduction ratio of an image size of the output image from the document size with a second threshold, and a print controller to downsize the image data at the reduction ratio in the printing mode set by the printing-mode setting unit to print the output image.

### Second Aspect

In the serial inkjet printer according to the first aspect, the printing-mode setting unit selects a second printing mode adopting a higher image quality than the first printing mode when the document size is equal to or greater than the first threshold and the reduction ratio is equal to or smaller than the second threshold, and selects a first printing mode adopting a faster speed than the second printing mode when the document size is not equal to or greater than the first threshold or the reduction ratio is not equal to or smaller than the second threshold.

### Third Aspect

The serial inkjet printer according to the second aspect includes a display controller to control a display to display a when-size-reduced image quality mode setting field for receiving a selection as to whether the printing-mode setting unit automatically selects the printing mode according to the first result of comparison and the second result of comparison, and an operation acceptance unit to receives the selection received through the when-size-reduced image quality mode setting field.

### Fourth Aspect

In the serial inkjet printer according to the third aspect, the operation acceptance unit receives a setting of the first threshold and the second threshold made by a user.

### Fifth Aspect

In the serial inkjet printer according to the fourth aspect, the display controller controls a display to display an image type of the image data in a selectable manner, and the operation acceptance unit receives selection of the image type of the image data, the printing-mode setting unit selects the printing mode according to a result of comparison of the document size with the first threshold associated in advance with the image type received through the operation acceptance unit and a result of comparison of the reduction ratio with the second threshold associated in advance with the image type received through the operation acceptance unit.

### Sixth Aspect

In the serial inkjet printer according to the fifth aspect, the first threshold and the second threshold received by the operation acceptance unit are stored, and the display controller displays the first threshold and the second threshold, which are set by a user, in a selectable manner as a customized setting, together with the image type of the image data.

### Seventh Aspect

In the serial inkjet printer according to any one of the third aspect to the sixth aspect, the printing-mode setting unit selects a third printing mode when the document size is equal to or larger than the first threshold and the reduction ratio is equal to or smaller than a third threshold greater than the second threshold, where a faster printing speed is adopted in an order of the first printing mode, the third printing mode, and the second printing mode and a greater image quality is adopted in an order of the second printing mode, the third printing mode, and the first printing mode.

### Eighth Aspect

In the serial inkjet printer according to any one of the third aspect to the sixth aspect, the printing-mode setting unit selects the second printing mode when the document size is equal to or greater than the first threshold, which is set by a user, and is equal to or smaller than the second threshold, which is set by a user, and selects a third printing mode when the document size is equal to or greater than a fourth threshold, which is set by a user and is smaller than the first threshold, and is equal to or smaller than a third threshold, which is set by a user and is greater than the second threshold, where a faster printing speed is adopted in an order of the first printing mode, the third printing mode, and the second printing mode and a greater image quality is adopted in an order of the second printing mode, the third printing mode, and the first printing mode.

### Ninth Aspect

In the serial inkjet printer according to any one of the third aspect to the eighth aspect, when a predetermined operation is performed by a user, only an area of the image data determined by a minimum amount of paper feed in a sub-scanning direction is printed in the printing mode selected based on the first threshold and the second threshold received by the operation acceptance unit.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions.

What is claimed is:

1. A serial inkjet printer comprising
circuitry configured to:
select a printing mode according to a first result of comparison of a document size in image data with a first threshold and a second result of comparison of a reduction ratio of an image size of an output image from the document size with a second threshold; and
downsize the image data at the reduction ratio in the printing mode to print the output image.

2. The serial inkjet printer according to claim 1,
wherein the circuitry
selects a second printing mode adopting a higher image quality than a first printing mode adopting a faster speed than the second printing mode when the document size is equal to or greater than the first threshold and the reduction ratio is equal to or smaller than the second threshold, and
selects the first printing mode when the document size is smaller than the first threshold or the reduction ratio is greater than the second threshold.

3. The serial inkjet printer according to claim 2,
wherein the circuitry controls a display to display a size-reduced image quality mode setting field for receiving a selection as to whether the circuitry automatically selects the printing mode according to the first result of comparison and the second result of comparison, and
wherein the circuitry receives the selection received through the size-reduced image quality mode setting field.

4. The serial inkjet printer according to claim 3,
wherein the circuitry receives a setting of the first threshold and the second threshold.

5. The serial inkjet printer according to claim 4,
wherein the circuitry controls a display to display an image type of the image data in a selectable manner,
wherein the circuitry receives selection of the image type of the image data, and
wherein the circuitry selects the printing mode according to a result of comparison of the document size with the first threshold associated in advance with the image type and a result of comparison of the reduction ratio with the second threshold associated in advance with the image type.

6. The serial inkjet printer according to claim 5,
wherein the first threshold and the second threshold are stored, and
wherein the circuitry displays the first threshold and the second threshold in a selectable manner as a customized setting, together with the image type of the image data.

7. The serial inkjet printer according to claim 3,
wherein the circuitry selects a third printing mode when the document size is equal to or larger than the first threshold and the reduction ratio is equal to or smaller than a third threshold greater than the second threshold, where a faster printing speed is adopted in an order of the first printing mode, the third printing mode, and the second printing mode and a greater image quality is adopted in an order of the second printing mode, the third printing mode, and the first printing mode.

8. The serial inkjet printer according to claim 3,
wherein the circuitry
selects the second printing mode when the document size is equal to or greater than the first threshold and is equal to or smaller than the second threshold, and
selects a third printing mode when the document size is equal to or greater than a fourth threshold smaller than the first threshold and is equal to or smaller than a third threshold greater than the second threshold,
where a faster printing speed is adopted in an order of the first printing mode, the third printing mode, and the second printing mode and a greater image quality is adopted in an order of the second printing mode, the third printing mode, and the first printing mode.

9. The serial inkjet printer according to claim 3,
wherein when a predetermined operation is performed, only an area of the image data determined by a minimum amount of paper feed in a sub-scanning direction is printed in the printing mode selected based on the first threshold and the second threshold.

10. A non-transitory computer-readable recording medium storing a program for causing a computer to execute a method, the method comprising:
reducing image data to an output image smaller than a document size of the image data;
determining a printing mode according to a first result of comparison of the document size with a first threshold and a second result of comparison of a reduction ratio of an image size of the output image from the document size with a second threshold; and
sending the printing mode determined in the determining to a serial inkjet printer.

11. A printing system comprising:
a serial inkjet printer to print image data with the image data reduced to an output image smaller than a document size of the image data; and
a terminal device to communicate with the serial inkjet printer through a network,
the terminal device including first circuitry configured to
determine a printing mode according to a first result of comparison of the document size with a first threshold and a second result of comparison of a reduction ratio of an image size of the output image from the document size with a second threshold, and
send the printing mode to the serial inkjet printer,
the serial inkjet printer including second circuitry configured to
downsize the image data at the reduction ratio to print the output image in the printing mode sent from the terminal device.
